(19) United States
(12) Patent Application Publication
(10) Pub. No.: US 2013/0034678 A1
(43) Pub. Date: Feb. 7, 2013

(54) NUMBER CARD

(71) Applicants: Kazuhiro YAMAMOTO, Ehime (JP); Hiroshi HOSAKA, Ehime (JP); Yoshitake SHIGEMATSU, Ehime (JP)

(72) Inventors: Kazuhiro YAMAMOTO, Ehime (JP); Hiroshi HOSAKA, Ehime (JP); Yoshitake SHIGEMATSU, Ehime (JP)

(73) Assignee: NITTO LIFETEC CORPORATION, Matsuyama-shi (JP)

(21) Appl. No.: 13/563,972

(22) Filed: Aug. 1, 2012

(30) Foreign Application Priority Data
Aug. 2, 2011 (JP) 2011-169363

(51) Int. Cl. C09J 7/02; B32B 33/00

(52) U.S. Cl. 428/41.8; 428/195.1

(57) ABSTRACT

A number card 10a includes: a backing 11 including a front face 11a and a rear face 11b opposite to the front face 11a; a display portion formed on the front face 11a of the backing 11; a rear-face-side pressure-sensitive adhesive portion 12 formed on the rear face 11b of the backing 11; and a releasing portion 13 formed on the rear face 11b of the backing 11, wherein the rear-face-side pressure-sensitive adhesive portion 12 and the releasing portion 13 are formed in line symmetry on the rear face 11b of the backing 11.

### CROSS REFERENCE TO RELATED APPLICATION

The present invention claims the priority of Japanese Patent Application No. 2011-169363, which is incorporated herein by reference in its entirety.

### BACKGROUND OF THE INVENTION

1. Field of the Invention

The present invention relates to a number card.

2. Description of the Related Art

At present, number cards are being used for the purpose of identifying individuals and the like, for example, when a sporting event such as a marathon race is held and when gymnasium clothes are worn at school.

Number cards of such a kind include those disclosed in, for example, Japanese Patent Laid-Open No. 2009-244680 (Patent Document 1) and Japanese Utility Model Laid-Open No. 1-128370 (Patent Document 2). The number card of the Patent Document 1 is configured such that an insertion hole for inserting a fitting member such as a safety pin thereinto is formed on each of four corners. The number card of the Patent Document 2 is configured such that a pressure-sensitive adhesive tape is attached to the rear face of a number-bib main body and the pressure-sensitive adhesive tape is covered with cover paper.

### PRIOR ART DOCUMENTS

### Patent Documents

Patent Document 1: Japanese Patent Laid-Open No. 2009-244680
Patent Document 2: Japanese Utility Model Laid-Open No. Hei-1-128370

However, when attaching the number card of the Patent Document 1 described above to the clothes of an athlete, a student, and the like, it is necessary to insert each of the fitting members such as safety pins into the four insertion holes of the number card and also attach each fitting member to the clothes. Because of this, a problem exists in that it takes some time and effort to attach the number card of the Patent Document 1 to clothes.

Moreover, when attaching the number card of the Patent Document 2 to the clothes of an athlete, a student, and the like, it is necessary to peel off the cover paper to attach the pressure-sensitive adhesive tape to the clothes. Because of this, a problem exists in that attaching the number card of the Patent Document 2 to clothes will make the cover paper become a disused article, thus generating trash.

In view of the above described problems, it is an object of the present invention to provide a number card and a sheet for number card, which can reduce the time and effort at the time of usage and reduce the trash generated at the time of usage.

### SUMMARY OF THE INVENTION

According to a first aspect of the present invention, there is provided a number card that includes: a backing including a front face and a rear face opposite to the front face; a display portion formed on the front face of the backing; a rear-face-side pressure-sensitive adhesive portion formed on the rear face of the backing; and a releasing portion formed on the rear face of the backing, wherein the rear-face-side pressure-sensitive adhesive portion and the releasing portion are formed in line symmetry on the rear face of the backing.

According to a second aspect of the present invention, there is provided a number card that includes: a backing including a front face and a rear face opposite to the front face; a front-face-side pressure-sensitive adhesive portion formed on the front face of the backing; a display member formed on the front-face-side pressure-sensitive adhesive portion; a rear-face-side pressure-sensitive adhesive portion formed on the rear face of the backing; and a releasing portion formed on the rear face of the backing, wherein the rear-face-side pressure-sensitive adhesive portion and the releasing portion are formed in line symmetry on the rear face of the backing.

According to the number card in the first and second aspects of the present invention, since the rear-face-side pressure-sensitive adhesive portion and the releasing portion are formed in line symmetry on the rear face of the backing, folding the number card along the symmetry axis such that the rear faces of the folded backing are opposed to each other will result in that the rear-face-side pressure-sensitive adhesive portion and the releasing portion are brought to overlap each other, and therefore there is no need of a releasing paper for covering the rear-face-side pressure-sensitive adhesive portion. As the result of this, the releasing paper covering the rear-face-side pressure-sensitive adhesive portion will not be left as trash at the time of usage.

Moreover, the number card can be attached to an attaching portion such as clothes by sticking the rear-face-side pressure-sensitive adhesive portion to the attaching portion. Therefore, it is possible to attach the number card to an attaching portion with reduced time and effort compared with the case where each of a plurality of fitting members such as safety pins is attached to an attaching portion.

As described so far, the present invention can provide a number card which can reduce time and effort at the time of usage, and also reduce the trash generated at the time of usage.

According to a third aspect of the present invention, there is provided a sheet for number card, in which the sheet is a sheet for use in the number cards in the second aspect described above, including: a backing having a front face and a rear face opposite to the front face; a front-face-side pressure-sensitive adhesive portion formed on the front face of the backing; a releasing member formed so as to cover the front-face-side pressure-sensitive adhesive portion, a rear-face-side pressure-sensitive adhesive portion formed on the rear face of the backing; and a releasing portion formed on the rear face of the backing, wherein the rear-face-side pressure-sensitive adhesive portion and the releasing portion are formed in line symmetry on the rear face of the backing.

According to the sheet for number card of the present invention, it is possible to form the number card in the second aspect of the present invention by detaching the releasing member from the front-face-side pressure-sensitive adhesive portion and sticking the display member of the number card on the front-face-side pressure-sensitive adhesive portion. Thus, the present invention can provide a sheet for number card for providing a number card which can reduce time and effort at the time of usage, and also reduce the trash generated at the time of usage.

The above-described number card is preferably configured such that the rear-face-side pressure-sensitive adhesive portion and the releasing portion are alternately formed in stripes.

The above-described sheet for number card is preferably configured such that the rear-face-side pressure-sensitive adhesive portion and the releasing portion are alternately formed in stripes.

This configuration allows easy formation of the rear-face-side pressure-sensitive adhesive portion and the releasing portion, and therefore is advantageous from an industrial viewpoint.

As so far described, according to the present invention, it is possible to provide a number card and a sheet for number card, which can reduce time and effort at the time of usage, and also reduce the trash generated at the time of usage.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view schematically showing a number card in an opened state in Embodiment 1 of the present invention;

FIG. 2 is a rear view schematically showing the number card in an opened state in Embodiment 1 of the present invention;

FIG. 3 is a plan view schematically showing the number card in an opened state in Embodiment 1 of the present invention, in which the number card seen from the arrow III in FIG. 1 is shown;

FIG. 4 is a right side view schematically showing the number card in an opened state in Embodiment 1 of the present invention, in which the number card seen from the arrow IV in FIG. 1 is shown;

FIG. 5 is a left side view schematically showing the number card in an opened state in Embodiment 1 of the present invention, in which the number card seen from the arrow V in FIG. 1 is shown;

FIG. 6 is a front view schematically showing the number card in a folded state in Embodiment 1 of the present invention;

FIG. 7 is a plan view schematically showing the number card in a folded state in Embodiment 1 of the present invention, in which the number card seen from the arrow VII in FIG. 6 is shown;

FIG. 8 is a right side view schematically showing the number card in a folded state in Embodiment 1 of the present invention, in which the number card seen from the arrow VIII in FIG. 6 is shown;

FIG. 9 is a left side view schematically showing the number card in a folded state in Embodiment 1 of the present invention, in which the number card seen from the arrow IX in FIG. 6 is shown;

FIG. 10 is a sectional view taken along the line X-X in FIG. 6;

FIG. 11 is a front view schematically showing a number card in an opened state in Variant 1 of Embodiment 1 of the present invention;

FIG. 12 is a plan view schematically showing the number card in an opened state in Variant 1 of Embodiment 1 of the present invention, in which the number card seen from the arrow XII in FIG. 11 is shown;

FIG. 13 is a bottom view schematically showing the number card in an opened state in Variant 1 of Embodiment 1 of the present invention, in which the number card seen from the arrow XIII in FIG. 11 is shown;

FIG. 14 is a right side view schematically showing the number card in an opened state in Variant 1 of Embodiment 1 of the present invention, in which the number card seen from the arrow XIV in FIG. 11 is shown;

FIG. 15 is a front view schematically showing the number card in a folded state in Variant 1 of Embodiment 1 of the present invention;

FIG. 16 is a plan view schematically showing the number card in a folded state in Variant 1 of Embodiment 1 of the present invention, in which the number card seen from the arrow XVI in FIG. 15 is shown;

FIG. 17 is a bottom view schematically showing the number card in a folded state in Variant 1 of Embodiment 1 of the present invention, in which the number card seen from the arrow XVII in FIG. 15 is shown;

FIG. 18 is a right side view schematically showing the number card in a folded state in Variant 1 of Embodiment 1 of the present invention, in which the number card seen from the arrow XVIII in FIG. 15 is shown;

FIG. 19 is a sectional view taken along the line XIX-XIX in FIG. 15;

FIG. 20 is a front view schematically showing a number card in an opened state in Variant 2 of Embodiment 1 of the present invention;

FIG. 21 is a plan view schematically showing the number card in an opened state in Variant 2 of Embodiment 1 of the present invention, in which the number card seen from the arrow XXI in FIG. 20 is shown;

FIG. 22 is a plan view schematically showing the number card in a folded state in Variant 2 of Embodiment 1 of the present invention;

FIG. 23 is a front view schematically showing a number card in an opened state in Variant 3 of Embodiment 1 of the present invention;

FIG. 24 is a right side view schematically showing the number card in an opened state in Variant 3 of Embodiment 1 of the present invention, in which the number card seen from the arrow XXIV in FIG. 23 is shown;

FIG. 25 is a right side view schematically showing the number card in a folded state in Variant 3 of Embodiment 1 of the present invention;

FIG. 26 is a front view schematically showing a number card in an opened state in Variant 4 of Embodiment 1 of the present invention;

FIG. 27 is a right side view schematically showing the number card in an opened state in Variant 4 of Embodiment 1 of the present invention, in which the number card seen from the arrow XXVII in FIG. 26 is shown;

FIG. 28 is a front view schematically showing the number card in a folded state in Variant 4 of Embodiment 1 of the present invention;

FIG. 29 is a right side view schematically showing the number card in a folded state in Variant 4 of Embodiment 1 of the present invention, in which the number card seen from the arrow XXIX in FIG. 28 is shown;

FIG. 30 is a plan view schematically showing a number card in an opened state in Embodiment 2 of the present invention;

FIG. 31 is a plan view schematically showing a sheet for number card in Embodiment 3 of the present invention; and

FIG. 32 is a plan view schematically showing a sheet for number card in a variant of Embodiment 3 of the present invention.

### DETAILED DESCRIPTION OF THE PREFERRED EMBODIMENTS

Embodiments of the present invention will be described hereinafter with reference to the drawings. In the drawings, the same or corresponding elements have the same characters allocated, and description thereof will not be repeated.

### Embodiment 1

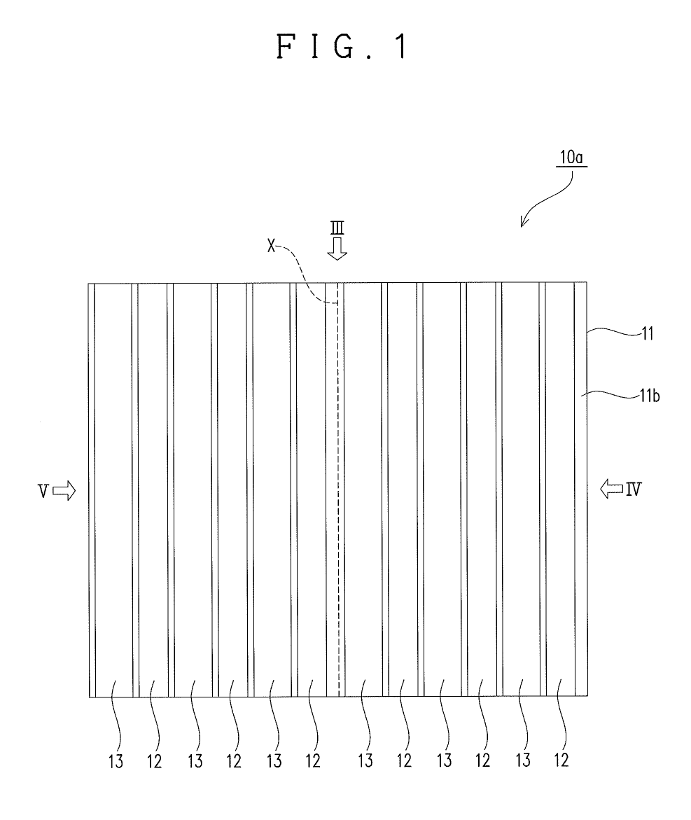

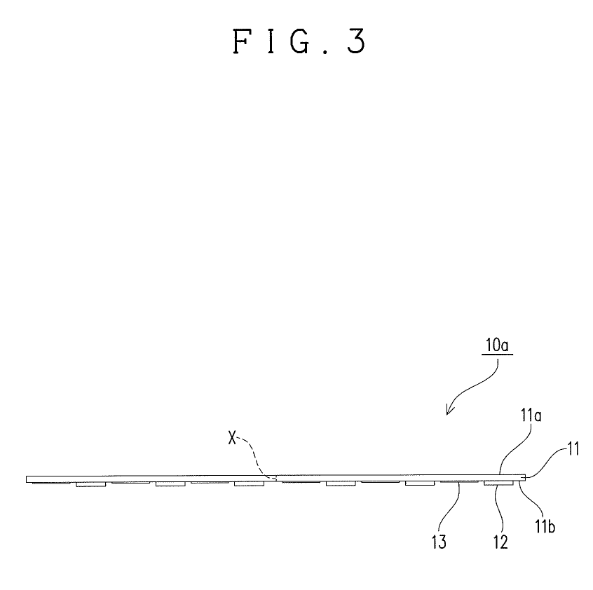

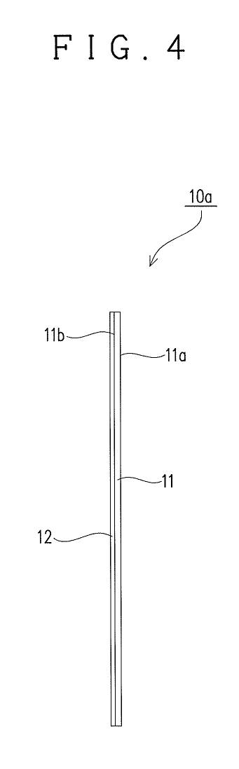

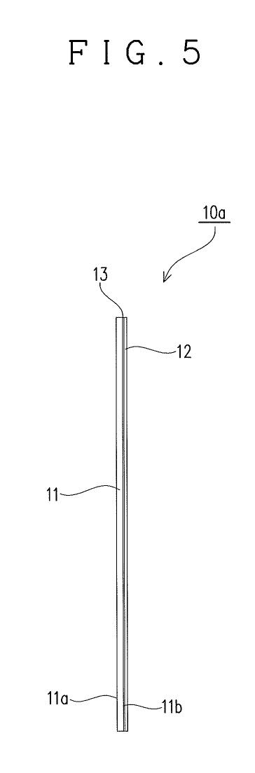

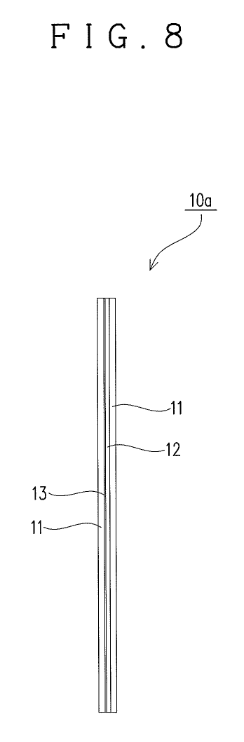

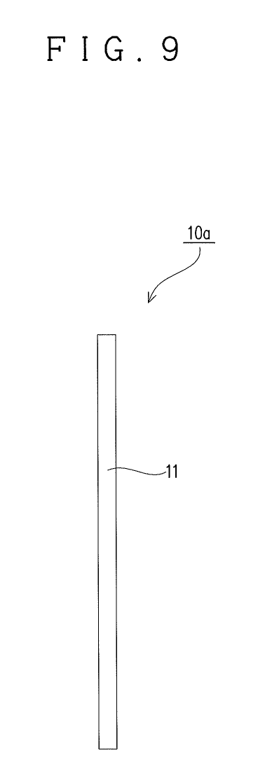

Referring to FIGS. 1 to 10, a number card 10a in one embodiment of the present invention will be described.

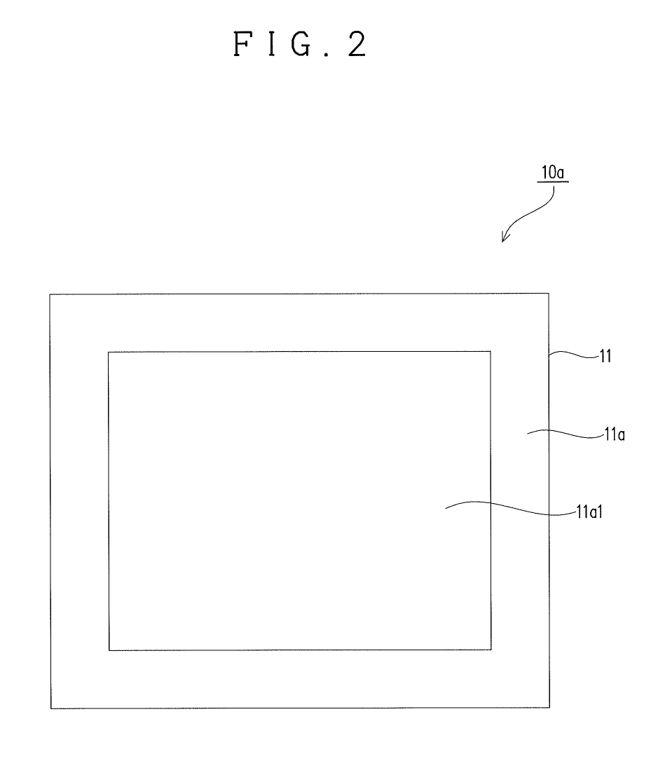

As shown in FIGS. 1 to 10, the number card 10a in the present embodiment includes: a backing 11 including a front face 11a, and a rear face 11b opposite to the front face 11a; a display portion 11a1 formed on the front face 11a of the backing 11 (see FIG. 2); a rear-face-side pressure-sensitive adhesive portion 12 formed on the rear face 11b of the backing 11; and a releasing portion 13 formed on the rear face 11b of the backing 11.

The front face 11a of the backing 11 is a surface for displaying the display portion 11a1 in which characters, numerals, and the like for identifying individuals are printed or written. In the present embodiment, the display portion 11a1 is formed in a part of the front face 11a, and no other layer is provided between the front face 11a and the display portion 11a1. When the front face 11a is used as the display portion 11a1, the display portion 11a1 may be a part or the whole of the front face 11a.

The rear face 11b of the backing 11 is for the purpose of forming a pressure-sensitive adhesive portion for sticking the number card 10a on clothes, etc.

Although the backing 11 of the present embodiment has a horizontally elongated rectangular shape in plan, the planar shape of the backing 11 will not be specifically limited, and may be another polygon, circle, ellipse, and the like.

The rear-face-side pressure-sensitive adhesive portion 12 is for the purpose of sticking the number card 10a on clothes.

The releasing portion 13 is for the purpose of protecting the rear-face-side pressure-sensitive adhesive portion 12 until the time of usage of the number card 10a by being stacked (brought to overlap) with the rear-face-side pressure-sensitive adhesive portion 12 when the number card 10a is folded along a symmetric axis X, and allowing the rear-face-side pressure-sensitive adhesive portion 12 to be easily peeled off from the releasing portion 13 at the time of usage of the number card 10a (when the folded number card 10a is unfolded).

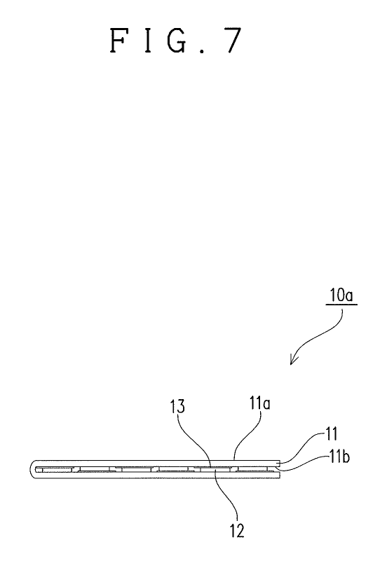

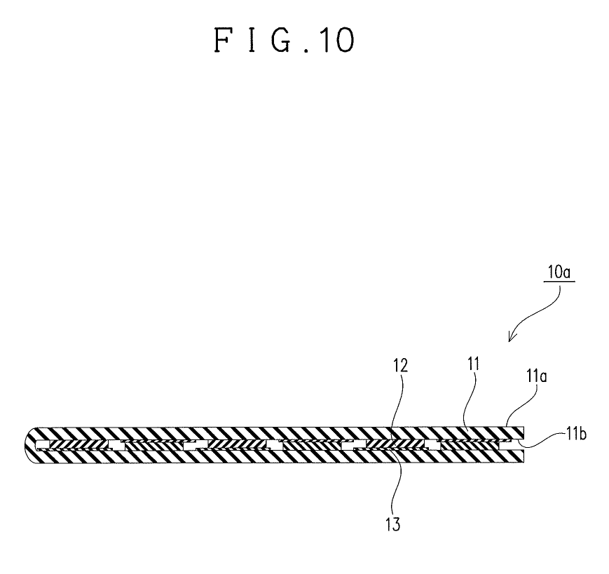

The rear-face-side pressure-sensitive adhesive portion 12 and the releasing portion 13 are formed in line symmetry on the rear face 11b of the backing 11. Note that line symmetry herein means that at least parts of the rear-face-side pressure-sensitive adhesive portion 12 and the releasing portion 13 are brought to overlap each other with the symmetric axis X being as the folding line. It is preferable that the releasing portion 13 encompasses the entire rear-face-side pressure-sensitive adhesive portion 12 when the number card is folded along the symmetric axis X as shown in FIGS. 7 and 10. In the meantime, the symmetric axis X of the present embodiment is the line connecting the centers of opposite long sides.

In the present embodiment, the symmetric axis X is positioned in parallel with the short side (longitudinal side), and the rear-face-side pressure-sensitive adhesive portion 12 and the releasing portion 13 extend in parallel with the symmetric axis X as shown in FIG. 1. That is, the rear-face-side pressure-sensitive adhesive portion 12 and the releasing portion 13 are alternately formed in stripes.

In the present embodiment, one or more of each of the rear-face-side pressure-sensitive adhesive portion 12 and the releasing portion 13 are formed, and a plurality of them may be formed depending on the area of the backing, and the like.

Moreover, both of the rear-face-side pressure-sensitive adhesive portion 12 and the releasing portion 13 are formed in each region defined by the symmetric axis X in the rear face 11b of the backing 11.

Furthermore, there is a region where neither of the rear-face-side pressure-sensitive adhesive portion 12 and the releasing portion 13 is formed therebetween, and the rear face 11b of the backing 11 is exposed in this region. That is, when seen from the rear face 11b side of the backing 11, the rear-face-side pressure-sensitive adhesive portion 12, the releasing portion 13, and the backing 11 therebetween are formed in stripes.

Now, the materials for making up the backing 11, the rear-face-side pressure-sensitive adhesive portion 12, and the releasing portion 13 will be described.

The material for making up the backing 11 is not specifically limited and, for example, paper, cloth, plastic film, non-woven fabric, and the like can be used. The backing 11 may be made up of a single layer or multiple layers.

The pressure-sensitive adhesive for making up the rear-face-side pressure-sensitive adhesive portion 12 is not specifically limited, and known pressure-sensitive adhesives can be used, such as rubber-based pressure-sensitive adhesives, urethane-based pressure-sensitive adhesives (acrylic urethane-based pressure-sensitive adhesives), acryl-based pressure-sensitive adhesives, silicone-based pressure-sensitive adhesives, polyester-based pressure-sensitive adhesives, polyamide-based pressure-sensitive adhesives, epoxy-based pressure-sensitive adhesives, vinyl alkyl ether-based pressure-sensitive adhesives, and fluorine-based pressure-sensitive adhesives. Moreover, the above-described pressure-sensitive adhesives may be used singly or in combination of two or more kinds. Among those described above, the rubber-based pressure-sensitive adhesives and the urethane (acrylic urethane)-based pressure-sensitive adhesives are particularly preferable.

Examples of the above-described rubber-based pressure-sensitive adhesives include rubber-based pressure-sensitive adhesives which utilize natural rubber or various synthetic rubbers as the base polymer. Examples of the rubber-based pressure-sensitive adhesives utilizing synthetic rubber as the base polymer include: styrene-based rubber (also called as styrene-based elastomer) such as styrene-butadiene (SB) rubber, styrene-isoprene (SI) rubber, styrene-isoprene-styrene block copolymer (SIS) rubber, styrene-butadiene-styrene block copolymer (SBS) rubber, styrene-ethylene-butylene-styrene block copolymer (SEBS) rubber, styrene-ethylene-propylene-styrene block copolymer (SEPS) rubber, styrene-ethylene-isoprene-styrene block copolymer (SIPS) rubber, and styrene-ethylene-propylene block copolymer (SEP) rubber; polyisoprene rubber; reclaimed rubber; butyl rubber; polyisobutylene; and variants thereof. Among those, pressure-sensitive adhesives of styrene-based elastomer are preferable, and SIS and SBS are more preferable.

One kind or mixtures of two or more kinds of those may be appropriately selected and used.

Moreover, softening agents, tackifying resins, bulking agents, and the like can be added to the synthetic rubber-based pressure-sensitive adhesives.

As the above-described urethane-based pressure-sensitive adhesives, known and commonly used urethane-based pressure-sensitive adhesives can be used and for example, although not specifically limited to, urethane-based pressure-sensitive adhesives disclosed in Japanese Patent No. 3860880 and Japanese Patent Laid-Open No. 2006-288690 can be suitably used. Among those, acrylic urethane-based pressure-sensitive adhesives made up of isocyanate/polyester polyol are preferable. Moreover, in the viewpoint of reducing the effects on clothes on which the number card 10a is stuck, the above-described acrylic urethane-based pressure-sensitive adhesives are preferably a foam type pressure-sensitive adhesive having bubbles. Such a foam type pressure-sensitive adhesive can be produced by, for example, a method for adding a known and commonly used foaming agent into the pressure-sensitive adhesive.

Moreover, the form of pressure-sensitive adhesives is not specifically limited and, for example, emulsion type pressure-sensitive adhesives, solvent type pressure-sensitive adhesives, thermally fusible pressure-sensitive adhesives (hot-melt type pressure-sensitive adhesives) and the like can be used. Here, among those described above, the thermally fusible pressure-sensitive adhesives (hot-melt type pressure-sensitive adhesives) are particularly preferably used from the advantages that they can be coated by melting them by heating without using a solvent, and even if the surface to be coated (the rear face 11b on which a rear-face-side pressure-sensitive adhesive portion is formed) is a porous surface (a surface made up of, for example, porous film and non-woven fabric), they can be directly applied to the porous surface to form the rear-face-side pressure-sensitive adhesive portion.

Moreover, the properties of pressure-sensitive adhesive are not limited and, for example, a pressure-sensitive adhesive having a thermosetting property (thermosetting pressure-sensitive adhesive) which cures due to reaction such as cross-linking by heating, and a pressure-sensitive adhesive having an active energy ray-curing property which cures due to reaction such as cross-linking by the irradiation of active energy ray (active energy ray-curable pressure-sensitive adhesive) may be used. Among those, an active energy ray-curable pressure-sensitive adhesive is suitable from the viewpoint that it is of a non-solvent type and is not likely to be excessively impregnated into a non-woven fabric, a porous backing, and the like. It is noted that the thermosetting pressure-sensitive adhesive may be appropriately added with a cross-linking agent, a polymerization initiator, and the like for manifesting a thermosetting property. Moreover, the active energy ray-curable pressure-sensitive adhesive may be appropriately added with a cross-linking agent, a photo polymerization initiator, and the like for manifesting an active energy ray-curing property.

The releasing treatment agent (mold releasing agent) for making up the releasing portion 13 is not specifically limited, and any one which can manifest a releasing property for the rear-face-side pressure-sensitive adhesive portion 12 may be used without specific limitation, examples of which include silicone-based releasing treatment agents, fluorine-based releasing treatment agents, and long-chain alkyl-based releasing treatment agents. Among those, silicone-based releasing treatment agents are particularly preferable in the present invention.

As the above-described silicone-based releasing treatment agent, non-solvent type silicone-based releasing treatment agents are preferable from the viewpoint of avoiding excessive impregnation in the cases where the backing 11 is a porous backing such as a non-woven fabric. Examples of such non-solvent type silicone-based releasing treatment agents include thermosetting silicone-based releasing treatment agents and active energy ray-curable silicone-based releasing treatment agents. Among those, active energy ray-curable silicone-based releasing treatment agents are particularly preferable from the viewpoint of avoiding thermal damages when a porous film is used as the backing 11. The above-described non-solvent type silicone-based releasing treatment agents can be used singly or in combination of two or more kinds.

As the above-described active energy ray-curable silicone-based releasing treatment agent, although there is no specific limitation provided it is a type of silicone-based releasing treatment agent which is cured by active energy ray (α-ray, (β-ray, γ-ray, neutron ray, electron ray, ultraviolet ray, etc.), a type of releasing treatment agent which cures due to cross-linking (curing reaction) by electron ray irradiation or ultraviolet ray irradiation to form a releasable film can be suitably used. The active energy ray-curable silicone-based releasing treatment agents can be used singly or in combination of two or more kinds.

As the above-described silicone-based releasing treatment agent which can be cured by ultraviolet irradiation, it is possible to use, for example, a releasing treatment agent of a cation polymerization type which cures due to cation polymerization, a radical polymerization type which cures due to radical polymerization, a radical addition type which cures due to radical addition polymerization, and a hydrosilylation reaction type which cures due to hydrosilylation reaction can be used, among which the cation polymerization type is preferable.

As such a releasing treatment agent, a commercial product, for example, “UV-9300” from Toshiba Silicone Co., Ltd can be used.

Now, an example of specific dimensions of the number card 10a of the present embodiment will be given. The longitudinal length (short side) of the backing 11 is, for example, 200 mm, the lateral length (long side) is, for example, 240 mm, and the thickness is, for example, not less than 200 μm and not more than 1000 μm. The width of the rear-face-side pressure-sensitive adhesive portion 12 is, for example, 14 mm, the length thereof is, for example, 200 mm, and the thickness thereof is, for example, not less than 40 μm and not more than 150 μm. The width of the releasing portion 13 is, for example, 18 mm, the length thereof is, for example, 200 mm, and the thickness thereof is, for example, not less than 0.1 μm and not more than 5 μm. The distance between the rear-face-side pressure-sensitive adhesive portion 12 and the releasing portion 13 without the symmetric axis X being interposed therebetween is, for example, 3 mm. The distance between the rear-face-side pressure-sensitive adhesive portion 12 and the releasing portion 13 with the symmetric axis X being interposed therebetween is, for example, 9 mm, the distance between the symmetric axis X and the rear-face-side pressure-sensitive adhesive portion 12 which is located on the left thereof in FIG. 1 is, for example, 6 mm, and the distance between the symmetric axis X and the releasing portion 13 which is located on the right thereof in FIG. 1 is, for example, 3 mm. The distance between the releasing portion 13 located on the left end and the left end edge of the backing 11 in FIG. 1 is, for example, 3 mm, and the distance between the rear-face-side pressure-sensitive adhesive portion 12 located on the right end and the right end edge of the backing 11 in FIG. 1 is, for example, 6 mm.

Now, the method for manufacturing a number card 10a in the present embodiment will be described.

First, a backing 11 including a front face 11a having a display portion 11a1, and a rear face 11b opposite to the front face 11a is prepared.

Next, a rear-face-side pressure-sensitive adhesive portion 12 and a releasing portion 13 are formed so as to be in line symmetry on the rear face 11b of the backing 11. The method for forming the rear-face-side pressure-sensitive adhesive portion 12 and the releasing portion 13 is not specifically limited, and for example, an appropriate coating method such as a roll coating method, a die coating method, a gravure coating method, a bar coating method, a melt blow method, and a curtain spray method can be utilized. The method for forming the rear-face-side pressure-sensitive adhesive portion 12 and the releasing portion 13 is preferably a spray method from the viewpoint of ensuring good air permeability.

Although the amount of application (solid component) of the rear-face-side pressure-sensitive adhesive portion 12 and the releasing portion 13 can be appropriately selected depending on the kind of the pressure-sensitive adhesive and the releasing treatment agent, the kind of the backing, and the like, the amount of application of the pressure-sensitive adhesive is, for example, not less than 10 g/m² and not more than 300 g/m², and preferably not less than 50 g/m² and not more than 150 g/m², and the amount of application of the releasing treatment agent is, for example, not less than 0.03 g/m² and not more than 3 g/m², and preferably not less than 0.3 g/m² and not more than 1.5 g/m².

The rear-face-side pressure-sensitive adhesive portion 12 and the releasing portion 13 may be formed at the same time, or either one of them may be formed first.

This makes it possible to manufacture the number card 10a in an opened state as shown in FIGS. 1 to 5.

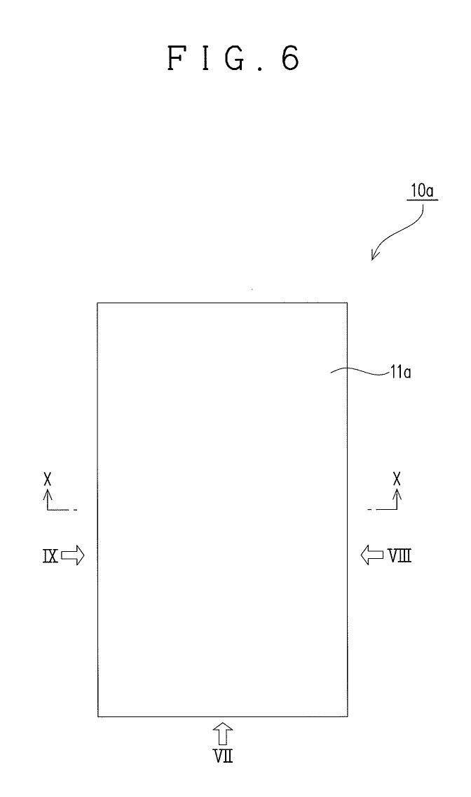

Next, as shown in FIGS. 6 to 10, the number card 10a is folded with the symmetric axis X as the center such that two parts of the rear face 11b of the backing 11 are brought to overlap each other. Since the rear-face-side pressure-sensitive adhesive portion 12 and the releasing portion 13 are formed in line symmetry on the rear face 11b of the backing 11, when the number card 10a is folded along the symmetric axis X, the rear-face-side pressure-sensitive adhesive portion 12 and the releasing portion 13 are brought to overlap each other, and therefore there is no need to insert a separate member such as a releasing paper for covering the rear-face-side pressure-sensitive adhesive portion 12 on the rear face 11b side. That is, the number card 10a in a folded state does not include a separate member such as a releasing paper.

By carrying out the above-described process, it is possible to manufacture the number card 10a shown in FIGS. 6 to 10.

Now, as the method for using the number card 10a of the present embodiment, a method for sticking the number card 10a on clothes will be described.

First, the folded number card 10a shown in FIGS. 6 to 10 is opened as shown in FIGS. 1 to 5. Since, at this moment, the releasing portion 13 covers the rear-face-side pressure-sensitive adhesive portion 12, there is no separate member such as a releasing paper between the rear-face-side pressure-sensitive adhesive portion 12 and the releasing portion 13, and therefore no trash will be generated.

Next, making the rear face 11b side of the backing 11 opposed to a predetermined location of clothes, the rear-face-side pressure-sensitive adhesive portion 12 is stuck on the clothes. Since this process only involves sticking of the number card 10a on clothes, it is possible to reduce time and effort compared with the case where each of fitting members such as a plurality of safety pins and hooks is attached to clothes. Moreover, since there is no need to make a hole on the number card and the clothes as in the case where a safety pin is used, it is possible to restrict damages on the number card 10a and the clothes. Further, when the number card 10a is attached to clothes, it is possible to reduce risks such as that a pin penetrates the clothes and pierces the skin as in the case where the safety pin is used. Furthermore, when the number card 10a is stuck on clothes, it is possible to reduce the occurrence of irregularities or creases on the clothes as in the case where a hook etc. is used, and restrict the rubbing against the skin.

Since the front face 11a of the backing 11 is positioned on the front-facing side as the result of the above-described process, the display portion 11a1 of the front face 11a will appear on the front face of the clothes (see FIG. 2). This allows the identification of individuals through the characters, numerals, and the like printed or written on the display portion 11a1 of the number card.

Here, after the use of the number card 10a of the present embodiment, the number card 10a is detached from the clothes. In this occasion as well, there are similar advantages as in the case of attaching the number card 10a to clothes, that is, the number card 10a can be easily detached.

Moreover, although a method for attaching the number card 10a to clothes has been described as the method for using the number card 10a, the attaching member to which the number card 10a is attached is not specifically limited to clothes. The number card 10a may be attached to a member other than clothes, and may be directly stuck on the skin.

### Variant 1

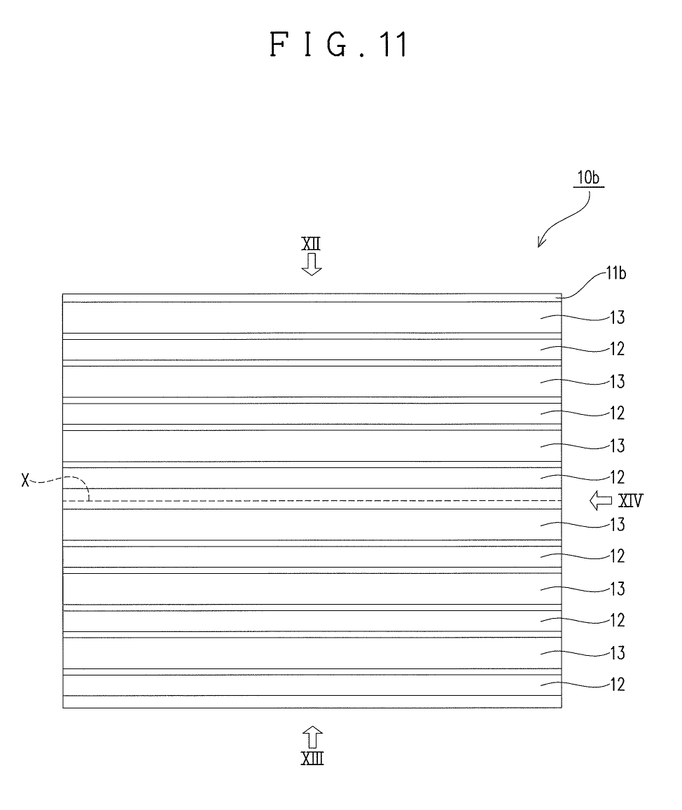

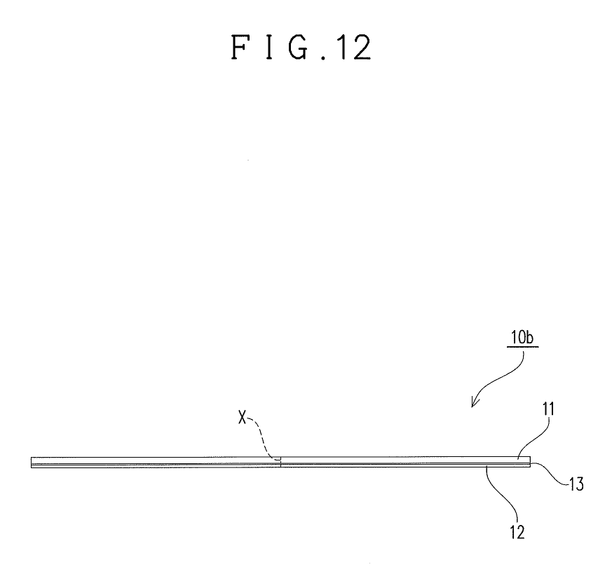

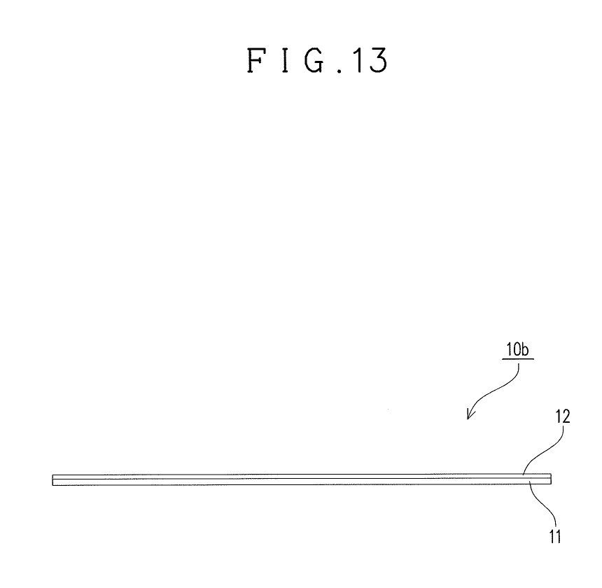

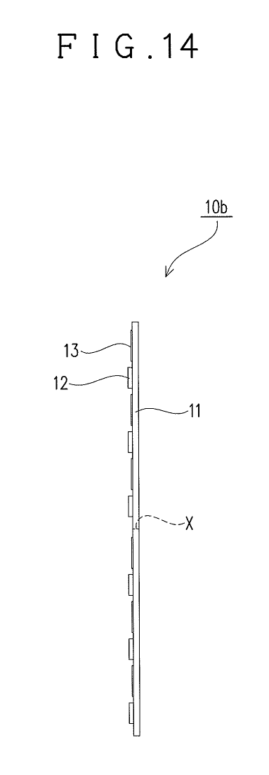

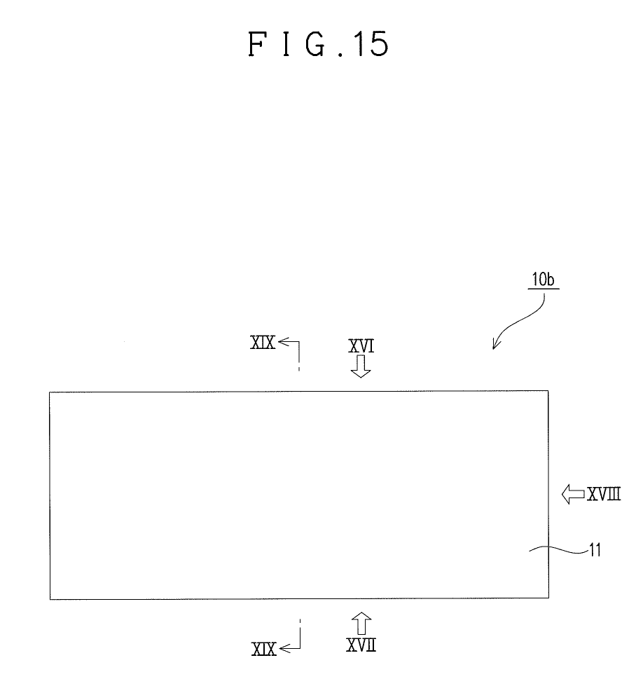

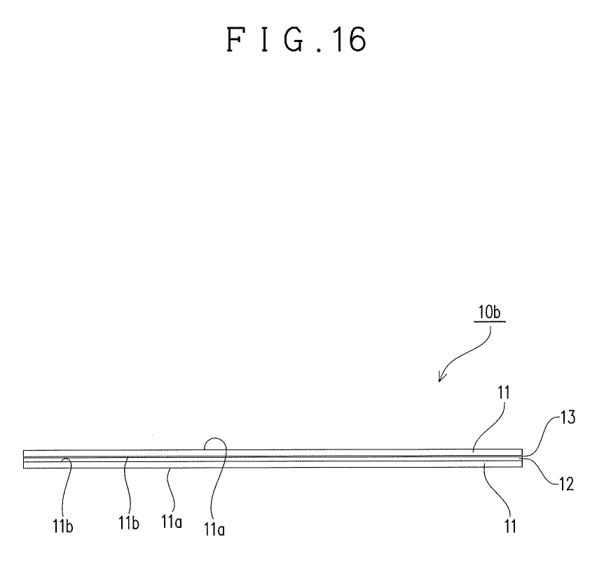

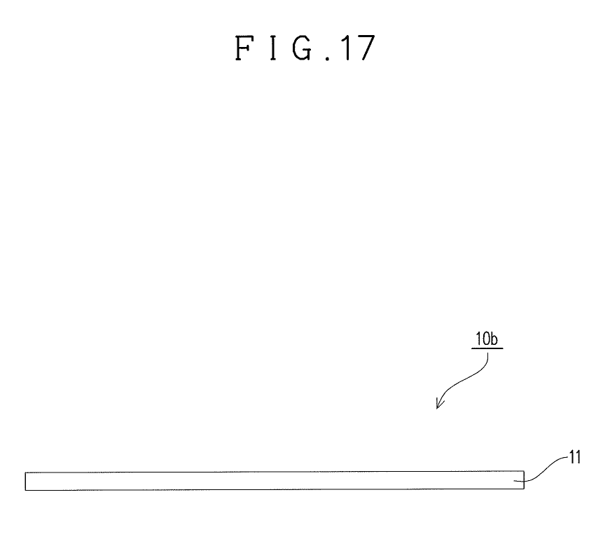

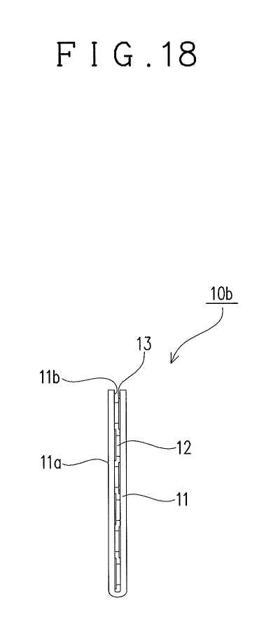

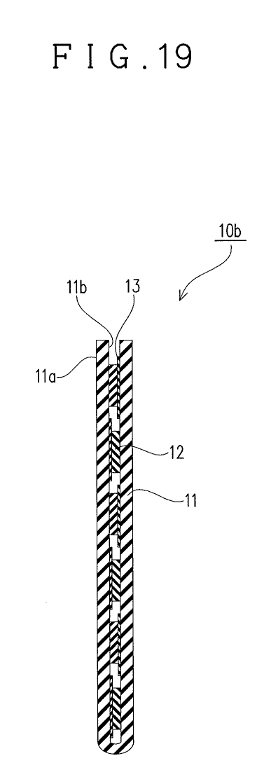

Referring to FIGS. 11 to 19, a number card 10b in Variant 1 of Embodiment 1 of the present invention will be described.

As shown in FIGS. 11 to 19, although the number card 10b of Variant 1 basically has the same configuration as that of the number card 10a of Embodiment 1, it differs therefrom in that the rear-face-side pressure-sensitive adhesive portion 12, the releasing portion 13, and the symmetric axis X are formed in parallel with the long side, and the rear-face-side pressure-sensitive adhesive portion 12 and the releasing portion 13 are formed in stripes.

The display portion 11a1 of Variant 1 is preferably configured such that identifiers such as characters and numerals are written horizontally, and no identifier is present on the symmetric axis X. In this case, even when a step occurs on the display portion 11a1 due to the symmetric axis X, it will not affect the identifiers and therefore the identifiers become easier to see.

An example of specific dimensions of the number card 10b of Variant 1 will be given. The longitudinal length (short side), lateral length (long side), and thickness of the backing 11 are, for example, the same as those of Embodiment 1. The width of the rear-face-side pressure-sensitive adhesive portion 12 is, for example, 10 mm, the length thereof is, for example, 240 mm, and the thickness thereof is, for example, not less than 40 μm and not more than 150 μm. The width of the releasing portion 13 is, for example, 15 mm, the length thereof is, for example, 240 mm, and the thickness thereof is, for example, not less than 0.1 μm and not more than 5 μm. The distance between the rear-face-side pressure-sensitive adhesive portion 12 and the releasing portion 13 without the symmetric axis X being interposed therebetween is, for example, 3 mm. The distance between the rear-face-side pressure-sensitive adhesive portion 12 and the releasing portion 13 with the symmetric axis X being interposed therebetween is, for example, 10 mm, the distance between the symmetric axis X and the rear-face-side pressure-sensitive adhesive portion 12 located thereabove in FIG. 11 is, for example, 6 mm, and the distance between the symmetric axis X and the releasing portion 13 located therebelow in FIG. 11 is, for example, 4 mm. The distance between the releasing portion 13 located at the upper end and the upper end edge of the backing 11 in FIG. 11 is, for example, 4 mm, and the distance between the rear-face-side pressure-sensitive adhesive portion 12 located at the lower end and the lower end edge of the backing 11 in FIG. 11 is, for example, 6 mm.

### Variant 2

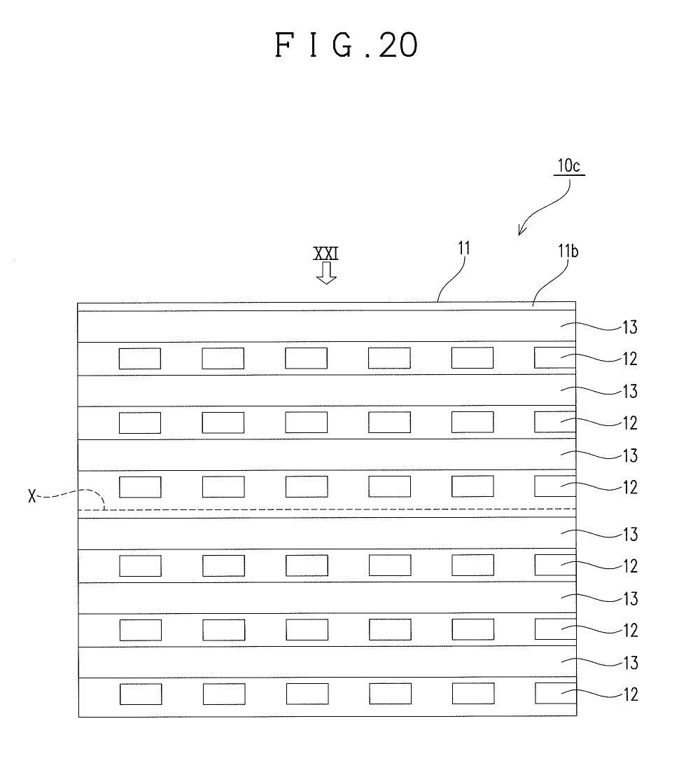

Referring to FIGS. 20 to 22, a number card 10c in Variant 2 of Embodiment 1 of the present invention will be described.

As shown in FIGS. 20 to 22, although the number card 10c of Variant 2 basically has the same configuration as that of the number card 10b of Variant 1, it differs therefrom in that the rear-face-side pressure-sensitive adhesive portion 12 is formed in a dot pattern.

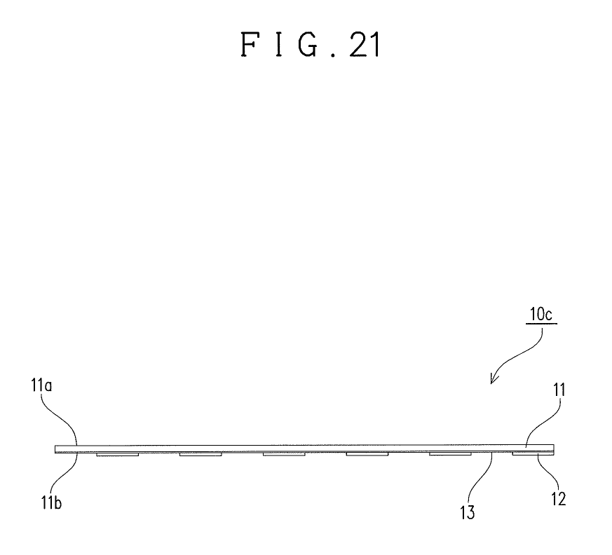

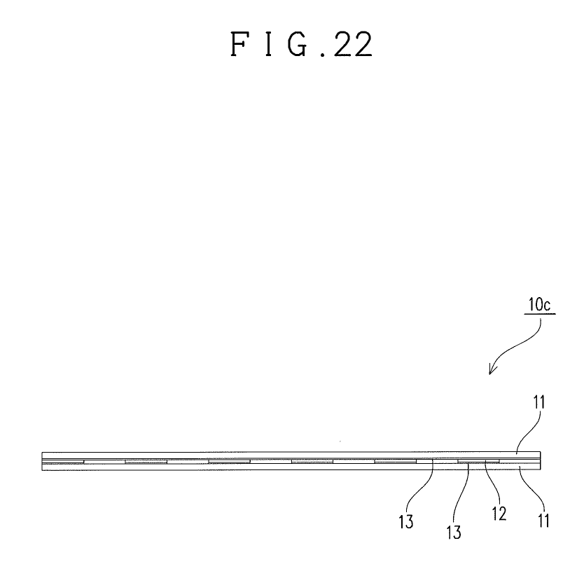

To be specific, as shown in FIGS. 20 and 21, among the rear-face-side pressure-sensitive adhesive portions 12 of Variant 2, the right end edge of the rear-face-side pressure-sensitive adhesive portion 12 which is formed at the right end is located on a short side (right end edge). As the result of this, in the folded number card 10c as shown in FIG. 22, an end portion is prevented from being bent sharply, since one part of the backing 11 is stuck on another part thereof by the rear-face-side pressure-sensitive adhesive portion formed on one short side.

An example of specific dimensions of the number card 10c of Variant 2 will be given. The longitudinal length, lateral length, and thickness of the backing 11 are, for example, the same as those of Embodiment 1. The width (vertical length in FIG. 20) of one rear-face-side pressure-sensitive adhesive portion 12 is, for example, 10 mm, the length (horizontal length in FIG. 20) thereof is, for example, 20 mm, and the thickness thereof is, for example, not less than 40 μm and not more than 150 μm. The distance between adjacent rear-face-side pressure-sensitive adhesive portions 12 is, for example, 20 mm. The width, length, and thickness of the releasing portion 13 are the same as those of Variant 1. The distance between the rear-face-side pressure-sensitive adhesive portion 12 and the releasing portion 13 without the symmetric axis X being interposed therebetween, the distance between the rear-face-side pressure-sensitive adhesive portion 12 and the releasing portion 13 with the symmetric axis X being interposed therebetween, the distance between the symmetric axis X and the rear-face-side pressure-sensitive adhesive portion 12 located thereabove in FIG. 20, and the distance between the symmetric axis X and the releasing portion 13 located therebelow in FIG. 20 are the same as those of Variant 1. The distance between the releasing portion 13 located at the upper end and the upper end edge of the backing 11 in FIG. 20, and the distance between the rear-face-side pressure-sensitive adhesive portion 12 located at the lower end and the lower end edge of the backing 11 in FIG. 20 are also the same as those of Variant 1.

### Variant 3

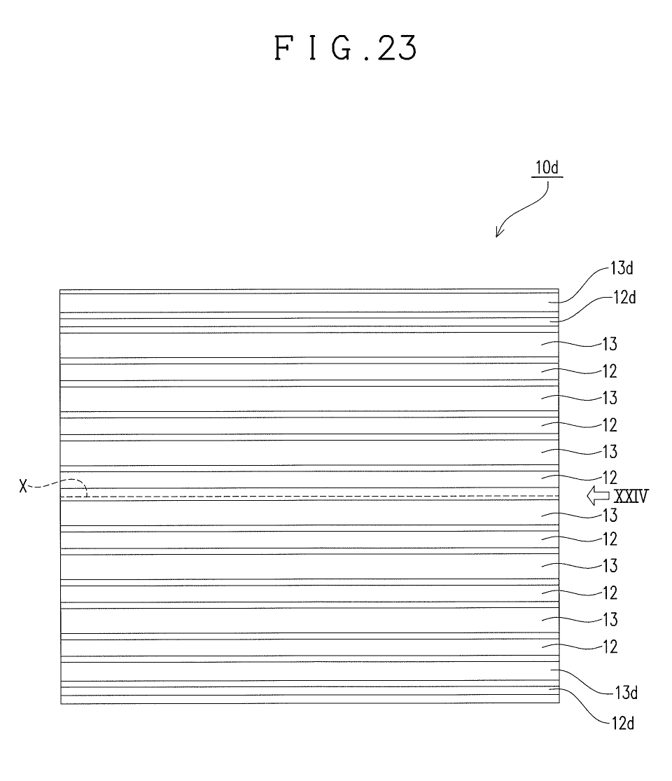

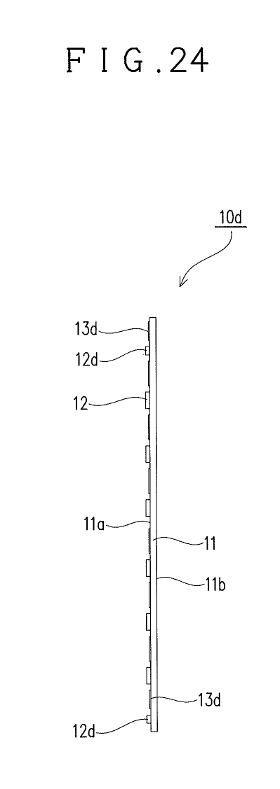

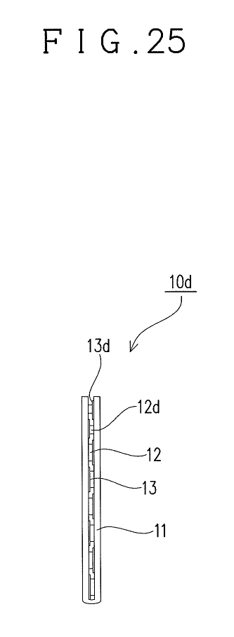

Referring to FIGS. 23 to 25, a number card 10d in Variant 3 of Embodiment 1 of the present invention will be described.

As shown in FIGS. 23 to 25, although the number card 10d of Variant 3 basically has the same configuration as that of the number card 10b of Variant 1, it differs therefrom in that the width of each of a rear-face-side pressure-sensitive adhesive portion 12d and a releasing portion 13d which are located at an end portion on a long side is narrower than the width of the other rear-face-side pressure-sensitive adhesive portions 12 and releasing portions 13.

The rear-face-side pressure-sensitive adhesive portion 12d and the releasing portion 13d which are located at an end portion on a long side refer to those which are formed at a position closest to the long side out of the rear-face-side pressure-sensitive adhesive portions 12 and the releasing portions 13 which extend in parallel with the long side. In the present embodiment, the releasing portion 13d which is formed at a position closest to the upper long side (upper end) and the rear-face-side pressure-sensitive adhesive portion 12d which is formed at a position closest to a lower long side (lower end) in FIG. 23, and the rear-face-side pressure-sensitive adhesive portion 12d which is formed at a position closest to the upper long side (upper end) and the releasing portion 13d which is formed at a position closest to the lower long side (lower end) in FIG. 23 have a narrower width than the other rear-face-side pressure-sensitive adhesive portions 12 and releasing portions 13.

In the case where the rear-face-side pressure-sensitive adhesive portion 12d and the releasing portion 13d which are located at an end portion have a narrower width than the other rear-face-side pressure-sensitive adhesive portions 12 and releasing portions 13, when the number card 10d is stuck on clothes, the vacant space from an end edge to the rear-face-side pressure-sensitive adhesive portion 12 can be reduced at the end portion on the side of the releasing portion 13d. This makes it possible to restrict the number card 10d from peeling off in a use state in which the number card 10d is stuck on the clothes.

An example of specific dimensions of the number card 10d of Variant 3 will be given. The longitudinal length (short side), lateral length (long side), and thickness of the backing 11 are, for example, the same as those of Embodiment 1. The width of the rear-face-side pressure-sensitive adhesive portion 12 in the portion other than the end portions of the long side is, for example, 8 mm, the width of the rear-face-side pressure-sensitive adhesive portion 12d at an end portion of the long side is, for example, 4 mm, and the length and the thickness thereof are the same as those of Embodiment 1. The width of the releasing portion 13 in the portion other than the end portions of the long side is, for example, 12 mm, the width of the releasing portion 13d at an end portion of the long side is, for example, 9 mm, and the length and the thickness thereof are the same as those of Embodiment 1. The distance between the rear-face-side pressure-sensitive adhesive portion 12 and the releasing portion 13 without the symmetric axis X being interposed therebetween is, for example, 3 mm. The distance between the rear-face-side pressure-sensitive adhesive portion 12 and the releasing portion 13 with the symmetric axis X being interposed therebetween is, for example, 6 mm, the distance between the symmetric axis X and the rear-face-side pressure-sensitive adhesive portion 12 located thereabove in FIG. 23 is, for example, 4 mm, and the distance between the symmetric axis X and the releasing portion 13 located therebelow in FIG. 23 is, for example, 2 mm. The distance between the releasing portion 13d located at a position closest to the upper end portion and the upper end edge of the backing 11 in FIG. 23 is, for example, 2 mm, and the distance between the rear-face-side pressure-sensitive adhesive portion 12d located at a position closest to the lower end and the lower end edge of the backing 11 in FIG. 23 is, for example, 4 mm.

### Variant 4

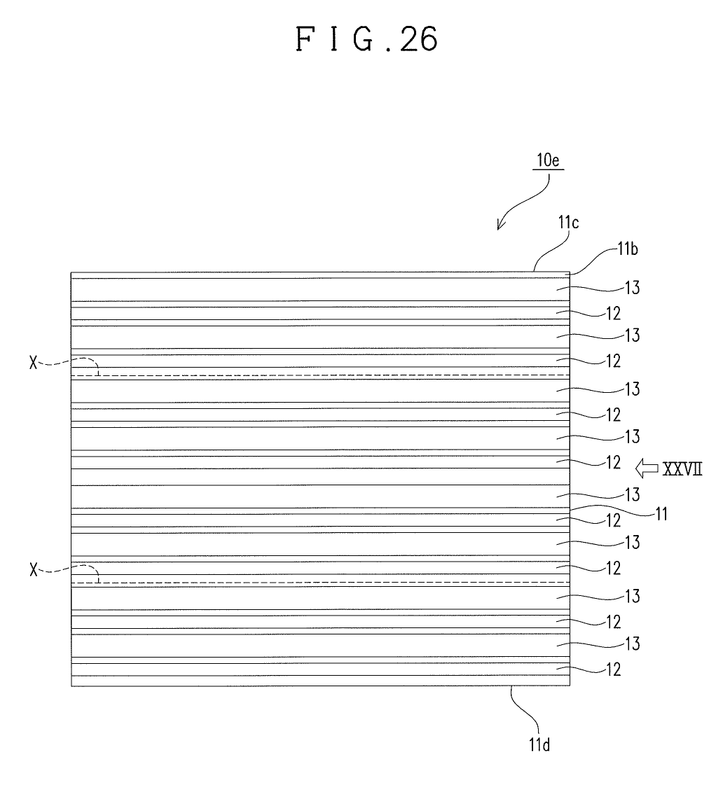

Referring to FIGS. 26 to 29, a number card 10e in Variant 4 of Embodiment 1 of the present invention will be described.

As shown in FIGS. 26 to 29, although the number card 10e of Variant 4 basically has the same configuration as that of the number card 10b of Variant 1, it differs therefrom in that it has two symmetric axes X.

The rear-face-side pressure-sensitive adhesive portion 12 and the releasing portion 13 are formed so as to be located in line symmetry with respect to each symmetric axis X.

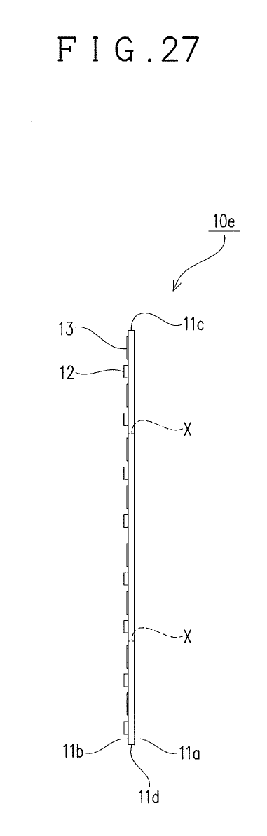

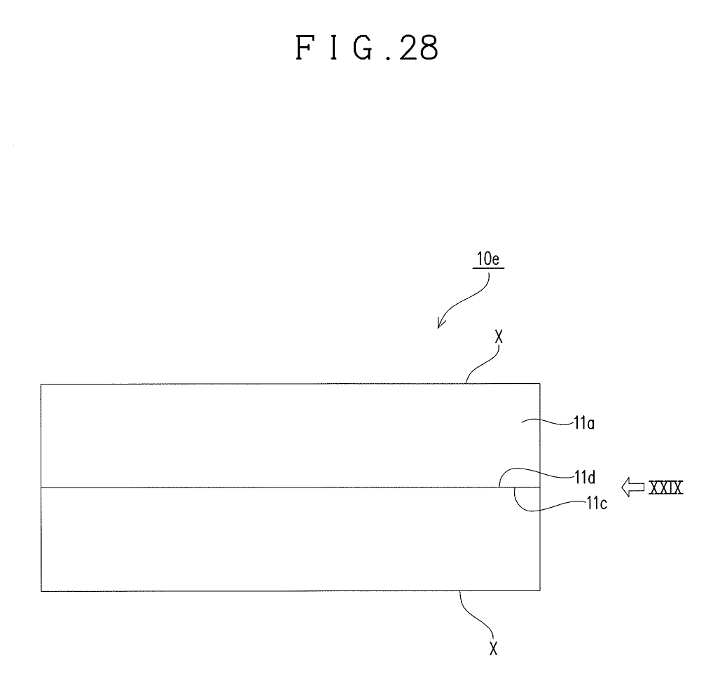

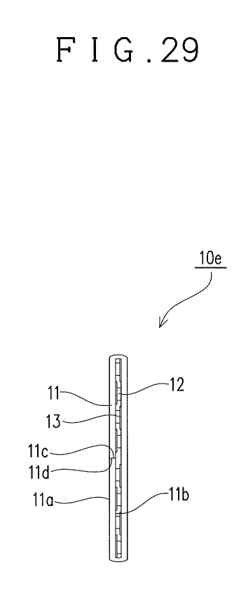

As shown in FIGS. 28 and 29, in a state in which the number card 10e of Variant 4 is folded, the upper end 11c of the backing 11 of FIGS. 26 and 27 is bent sharply along the upper symmetric axis X, and the lower end 11d of the backing 11 of FIGS. 26 and 27 is bent sharply along the lower symmetric axis X so that the upper end 11c and the lower end 11d are brought to be closer to each other. Adopting such a configuration can make the number card 10e more compact when it is folded.

An example of specific dimensions of the number card 10e of Variant 4 will be given. The longitudinal length, lateral length, and thickness of the backing 11 are, for example, the same as those of Embodiment 1. The width of the rear-face-side pressure-sensitive adhesive portion 12 is, for example, 6 mm, the length thereof is, for example, 240 mm, and the thickness thereof is, for example, not less than 40 μm and not more than 150 μm. The width of the releasing portion 13 is, for example, 11 mm, the length thereof is, for example, 240 mm, and the thickness thereof is, for example, not less than 0.1 μm and not more than 5 μm. The distance between the rear-face-side pressure-sensitive adhesive portion 12 and the releasing portion 13 without the symmetric axis X being interposed therebetween is, for example, 3 mm. The distance between the rear-face-side pressure-sensitive adhesive portion 12 and the releasing portion 13 with the symmetric axis X being interposed therebetween is, for example, 6 mm, the distance between the symmetric axis X and the rear-face-side pressure-sensitive adhesive portion 12 located thereabove in FIG. 26 is, for example, 4 mm, and the distance between the symmetric axis X and the releasing portion 13 located therebelow in FIG. 26 is, for example, 2 mm. The distance between the releasing portion 13 located at the upper end and the upper end 11c of the backing 11 in FIG. 26 is, for example, 3 mm, and the distance between the rear-face-side pressure-sensitive adhesive portion 12 located at the lower end and the lower end 11d of the backing 11 in FIG. 26 is, for example, 5 mm.

So far, description has been made taking example of the above described Embodiment 1 and its Variants 1 to 4, the rear-face-side pressure-sensitive adhesive portion 12 and the releasing portion 13 will not be specifically limited provided that they are disposed in line symmetry with the symmetric axis X being as the center, and the rear-face-side pressure-sensitive adhesive portion 12 and the releasing portion 13 may be formed so as to be aligned in a direction other than the direction along the outer circumference of the rear face 11b of the backing 11, and randomly formed. Moreover, the number of symmetric axes X is not limited to two or less, but may be set to three or more.

### Embodiment 2

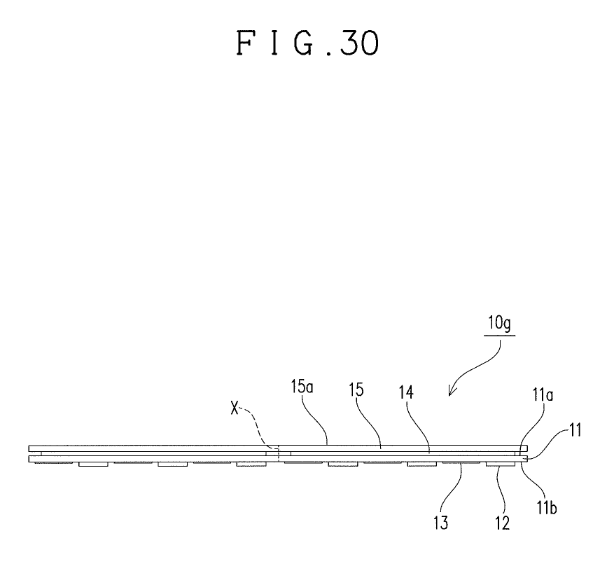

Referring to FIG. 30, although a number card 10g of the present embodiment basically has the same configuration as that of the number card 10a of Embodiment 1, it differs therefrom in that instead of a display portion 11a1 being formed on the front face 11a of the backing 11, a display member 15 is attached to the front face 11a via a front-face-side pressure-sensitive adhesive portion 14.

To be specific, the number card 10g includes: a backing 11 including a front face 11a and a rear face 11b opposite to the front face 11a; a front-face-side pressure-sensitive adhesive portion 14 formed on the front face 11a of the backing 11; a display member 15 formed on the front-face-side pressure-sensitive adhesive portion 14; a rear-face-side pressure-sensitive adhesive portion 12 formed on the rear face 11b of the backing 11; and a releasing portion 13 formed on the rear face 11b of the backing 11. On the rear face 11b of the backing 11, the rear-face-side pressure-sensitive adhesive portion 12 and the releasing portion 13 are formed in line symmetry.

The front-face-side pressure-sensitive adhesive portion 14 may be formed on a part of the front face 11a of the backing 11 or may cover the whole thereof.

The pressure-sensitive adhesive for making up the front-face-side pressure-sensitive adhesive portion 14 and the rear-face-side pressure-sensitive adhesive portion 12 of Embodiment 2 is the same as that of the rear-face-side pressure-sensitive adhesive portion 12 of Embodiment 1. The pressure-sensitive adhesives for making up the front-face-side pressure-sensitive adhesive portion 14 and the rear-face-side pressure-sensitive adhesive portion 12 may be same or different.

The display member 15 preferably covers the entirety of the front-face-side pressure-sensitive adhesive portion 14. The display member 15 has a display surface 15a on which characters and numerals, etc. for identifying individuals are printed or written. The display member 15 may use the same material as that of the backing 11.

Now, an example of specific dimensions of the number card 10g of the present embodiment will be given. The backing 11, the rear-face-side pressure-sensitive adhesive portion 12, and the releasing portion 13 are the same as those of Embodiment 1. The width of the front-face-side pressure-sensitive adhesive portion 14 is, for example, 100 mm, the length thereof is, for example, 200 mm, and the thickness thereof is, for example, not less than 40 μm and not more than 150 μm. The display member 15 is the same as the backing 11.

Now, a method for manufacturing a number card 10g in the present embodiment will be described.

First, a backing 11 having a front face 11a and a rear face 11b is prepared.

Next, a front-face-side pressure-sensitive adhesive portion 14 is formed on the front face 11a of the backing 11. The method for forming the front-face-side pressure-sensitive adhesive portion 14 is not specifically limited, and the same method as that for forming the rear-face-side pressure-sensitive adhesive portion 12 of Embodiment 1 may be adopted.

Next, a display member 15 is formed on the front-face-side pressure-sensitive adhesive portion 14. The surface opposite to the display surface 15a of the display member 15 is stuck on the front-face-side pressure-sensitive adhesive portion 14.

Next, the rear-face-side pressure-sensitive adhesive portion 12 and the releasing portion 13 are formed in line symmetry on the rear face 11b side of the backing 11. Since this process is the same as that of Embodiment 1, description thereof will not be repeated.

It is noted that the process of forming the rear-face-side pressure-sensitive adhesive portion 12 and the releasing portion 13 on the rear face 11b of the backing 11 may be carried out prior to or concurrently with the process of forming the front-face-side pressure-sensitive adhesive portion 14 and the display member 15 on the front face 11a of the backing 11.

By carrying out the above-described processes, it is possible to manufacture the number card 10g shown in FIG. 30.

Next, the number card 10g is folded with the symmetric axis X being the center such that one part of the rear face 11b of the backing 11 is brought to overlap with another part thereof. At this moment, since the rear-face-side pressure-sensitive adhesive portion 12 and the releasing portion 13 are formed in line symmetry on the rear face 11b of the backing 11, when the number card 10g is folded along the symmetric axis X, the rear-face-side pressure-sensitive adhesive portion 12 and the releasing portion 13 are brought to overlap each other, and therefore there is no need for a separate member such as a releasing paper for covering the rear-face-side pressure-sensitive adhesive portion 12 on the rear face 11b side.

By carrying out the process, it is possible to fold the number card 10g shown in FIG. 30.

Since the method for using the number card 10g in the present embodiment is the same as in Embodiment 1, description thereof will not be repeated.

It is noted that the configuration of the rear-face-side pressure-sensitive adhesive portion 12 and the releasing portion 13 on the rear face 11b side of the backing 11 in the number card 10g of the present embodiment is the same as that of the rear-face-side pressure-sensitive adhesive portion 12 and the releasing portion 13 on the rear face 11b side of the backing 11 of the number card 10a of Embodiment 1 of FIGS. 1 to 10. Similarly, the configurations of the rear-face-side pressure-sensitive adhesive portion 12 and the releasing portion 13 on the rear face 11b side of the backing 11 of the number cards 10b to 10e of Variants 1 to 4 of Embodiment 1 may be applied to the present embodiment.

### Embodiment 3

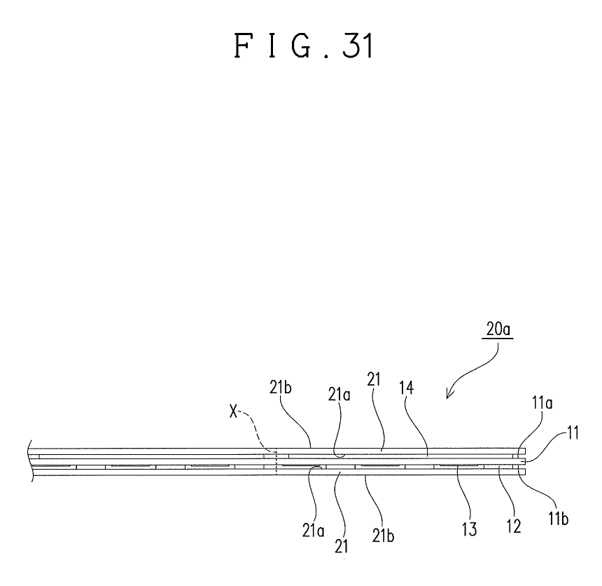

Referring to FIG. 31, one embodiment of a sheet for number card of the present invention will be described. A sheet for number card 20a of the present embodiment is a sheet (intermediate product) which is used for the number card 10g of Embodiment 2.

To be specific, the sheet for number card 20a includes: a backing 11 having a front face 11a and a rear face 11b opposite to the front face 11a; a front-face-side pressure-sensitive adhesive portion 14 formed on the front face 11a of the backing 11; a releasing member 21 having a releasing surface 21a formed so as to cover the front-face-side pressure-sensitive adhesive portion 14; a rear-face-side pressure-sensitive adhesive portion 12 formed on the rear face 11b of the backing 11; a releasing portion 13 formed on the rear face 11b of the backing 11; and a releasing member 21 having a releasing surface 21b formed so as to cover the rear-face-side pressure-sensitive adhesive portions 12. The rear-face-side pressure-sensitive adhesive portion 12 and the releasing portion 13 are formed in line symmetry on the rear face 11b of the backing 11.

The sheet for number card 20a has a tape-like shape which extends in the longitudinal direction and is held, for example, in a form of being wound up in a roll.

The backing 11 and the releasing member 21 extend in the longitudinal direction. The front-face-side pressure-sensitive adhesive portion 14 may be formed on a part of the front face 11a of the backing 11, or may extend in the longitudinal direction (not shown) as with the backing 11.

The releasing member 21 has a backing and a releasing surface 21a formed on at least one surface of the backing. That is, the releasing surface 21a is disposed on the surface opposed to the front-face-side pressure-sensitive adhesive portion 14 and the rear-face-side pressure-sensitive adhesive portion 12 in the releasing member 21. The releasing surface 21a is subject to the same mold releasing treatment as that for the releasing portion 13. The backing of the releasing member 21 is the same as the backing 11. For example, a known releasing paper may be used as the releasing member 21.

When the sheet for number card 20a is held, for example, in a form of being wound up in a roll, since the front-face-side pressure-sensitive adhesive portion 14 formed on the front face 11a of the backing 11 and the rear-face-side pressure-sensitive adhesive portion 12 formed on the rear face 11b of the backing 11 are covered with the releasing member 21, it is possible to prevent the sheet for number card 20a from sticking to each other even if it is stacked in that state.

Since the materials for making up the backing 11, the front-face-side pressure-sensitive adhesive portion 14, the rear-face-side pressure-sensitive adhesive portion 12, and the releasing portion 13 are the same as those of Embodiment 2, description thereof will not be repeated.

Now, a method for manufacturing a sheet for number card 20a in the present embodiment will be described.

First, a backing 11 having a front face 11a and a rear face 11b is prepared. Next, a front-face-side pressure-sensitive adhesive portion 14 is formed on the front face 11a of the backing 11. Moreover, a rear-face-side pressure-sensitive adhesive portion 12 and a releasing portion 13 are formed on the rear face 11b of the backing 11. Since these processes are the same as those of Embodiment 1 or 2, description thereof will not be repeated.

Next, a releasing member 21 is formed so as to cover the front-face-side pressure-sensitive adhesive portion 14 and the rear-face-side pressure-sensitive adhesive portion 12 with a releasing surface 21a.

By carrying out the processes described above, it is possible to manufacture the sheet for number card 20a shown in FIG. 31. Further, as needed, the sheet for number card 20a is wound up in a roll.

It is noted that the order of the process of forming the rear-face-side pressure-sensitive adhesive portion 12 and the releasing portion 13 on the rear face 11b side of the backing 11, the process of forming the front-face-side pressure-sensitive adhesive portion 14 and the display member 15 on the front face 11a side of the backing 11, and the process of forming the releasing member 21 is not specifically limited, and any of the processes may be carried out first, or concurrently with other process(es).

Now, a method for using the sheet for number card 20a in the present embodiment for the number card 10g of Embodiment 2 shown in FIG. 30 will be described.

A display member 15 (see FIG. 30) having a display surface 15a for identifying individuals is prepared. The sheet for number card 20a is processed into a size which allows the display member 15 to be attached thereto.

Next, the releasing member 21 covering the front-face-side pressure-sensitive adhesive portion 14 formed on the front face 11a is detached, and the display member 15 is stuck.

Next, the releasing member 21 that covers the rear-face-side pressure-sensitive adhesive portion 12 formed on the rear face 11b is detached. As the result of this, the number card 10g becomes an opened state shown in FIG. 30.

Next, the number card 10g is folded along the symmetric axis X such that the rear-face-side pressure-sensitive adhesive portion 12 and the releasing portion 13 are brought to overlap each other. This makes it possible to fold the number card 10g shown in FIG. 30.

### Variant

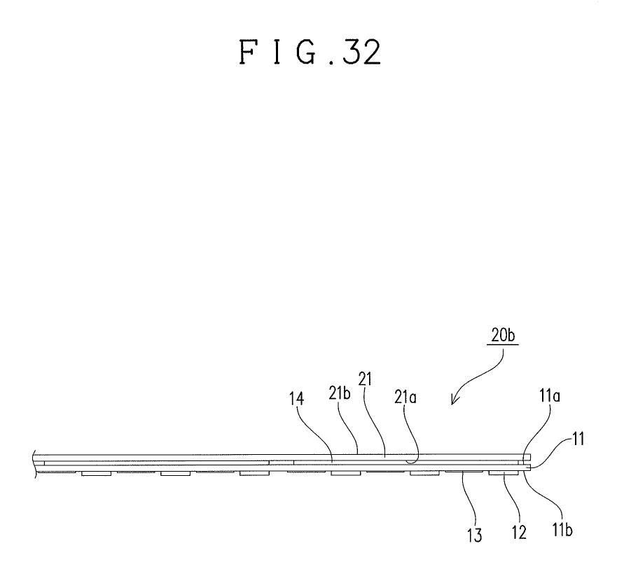

Referring to FIG. 32, a sheet for number card 20b in a variant of Embodiment 3 of the present invention will be described. The sheet for number card 20b is a sheet to be used for the number card 10g of Embodiment 2.

Although the sheet for number card 20b in the present embodiment basically has the same configuration as that of the sheet for number card 20a of Embodiment 3, it differs therefrom in that the releasing member 21 is disposed only on the front face 11a side of the backing 11, and the releasing surfaces 21a and 21b are formed on the front face and the rear face of the releasing member 21, respectively.

In the case where the sheet for number card 20b is wound up in a roll, the releasing surface 21b opposite to the releasing surface 21a opposed to the front-face-side pressure-sensitive adhesive portion 14 in the releasing member 21 covers the rear-face-side pressure-sensitive adhesive portion 12 formed on the rear face 11b of the backing 11. As the result of this, it is possible to prevent the sheet for number card 20b from sticking to each other by the front-face-side pressure-sensitive adhesive portion 14 and the rear-face-side pressure-sensitive adhesive portion 12 when they are stacked.

Although the method for manufacturing the sheet for number card 20b of the present variant is basically the same as that of the sheet for number card 20a of Embodiment 3, it differs therefrom in that releasing surfaces 21a and 21b are formed on the both sides of the releasing member 21, and that the releasing member 21 is formed such that only the front-face-side pressure-sensitive adhesive portion 14 is covered with the releasing surface 21a.

It is noted that although the releasing member 21 is formed so as to cover the front-face-side pressure-sensitive adhesive portion 14 on the front face 11a in the present variant, it may be formed so as to cover the rear-face-side pressure-sensitive adhesive portion 12 on the rear face 11b.

Moreover, in the sheets for number card 20a and 20b of Embodiment 3 and its variant, the configuration of the rear-face-side pressure-sensitive adhesive portion 12 and the releasing portion 13 on the rear face 11b side of the backing 11 is the same as that of the rear-face-side pressure-sensitive adhesive portion 12 and the releasing portion 13 on the rear face 11b side of the backing 11 of the number card 10a of Embodiment 1 of FIGS. 1 to 10. Similarly, the configurations of the rear-face-side pressure-sensitive adhesive portion 12 and the releasing portion 13 on the rear face 11b side of the backing 11 of the number cards 10b to 10e of Variants 1 to 4 of Embodiment 1 may be applied to the present embodiment.

While embodiments of the present invention have been described so far, it is expected from the beginning that features of each embodiment are appropriately combined. Moreover, it should be understood that the embodiments disclosed herein are by way of exemplification and not limitation in any respect. The scope of the present invention is defined by the terms of the claims, rather than the description above, and is intended to include any modification within the scope and meaning equivalent to the terms of the claims.

What is claimed is:

1. A number card, comprising:
a backing including a front face and a rear face opposite to the front face;
a display portion formed on the front face of the backing;
a rear-face-side pressure-sensitive adhesive portion formed on the rear face of the backing; and
a releasing portion formed on the rear face of the backing, wherein
the rear-face-side pressure-sensitive adhesive portion and the releasing portion are formed in line symmetry on the rear face of the backing.

2. The number card according to claim 1, wherein the rear-face-side pressure-sensitive adhesive portion and the releasing portion are alternately formed in stripes.

3. A number card, comprising:
a backing including a front face and a rear face opposite to the front face;
a front-face-side pressure-sensitive adhesive portion formed on the front face of the backing;
a display member formed on the front-face-side pressure-sensitive adhesive portion;
a rear-face-side pressure-sensitive adhesive portion formed on the rear face of the backing; and
a releasing portion formed on the rear face of the backing, wherein
the rear-face-side pressure-sensitive adhesive portion and the releasing portion are formed in line symmetry on the rear face of the backing.

4. The number card according to claim 3, wherein the rear-face-side pressure-sensitive adhesive portion and the releasing portion are alternately formed in stripes.

5. A sheet for number card for use in the number card according to claim 3, comprising:
a backing having a front face and a rear face opposite to the front face;
a front-face-side pressure-sensitive adhesive portion formed on the front face of the backing;
a releasing member formed so as to cover the front-face-side pressure-sensitive adhesive portion,
a rear-face-side pressure-sensitive adhesive portion formed on the rear face of the backing; and
a releasing portion formed on the rear face of the backing, wherein
the rear-face-side pressure-sensitive adhesive portion and the releasing portion are formed in line symmetry on the rear face of the backing.

6. The sheet for number card according to claim 5, wherein the rear-face-side pressure-sensitive adhesive portion and the releasing portion are alternately formed in stripes.
